(19) United States
(12) Patent Application Publication
(10) Pub. No.: US 2025/0044215 A1
(43) Pub. Date: Feb. 6, 2025

(54) SMART OIL AND GAS PIPELINE CORROSION COUPON

(71) Applicants: Qatar University, Doha (QA); Qatar Foundation for Education, Science and Community Development, Doha (QA)

(72) Inventors: Aboubakr Moustafa Abdullah, Doha (QA); Mostafa Hussien Ramadan Sliem, Doha (QA); Kamel Abdelmoniem Mohamed Eid, Doha (QA); Eman Mohamed AbdelKhalek Fayyad, Doha (QA); Nicholas John Laycock, Doha (QA); Abitha Ramesh, Doha (QA); Dhruv Arora, Doha (QA); Mohammed Maqbool Ahmed, Doha (QA); Mary P. Ryan, London (GB)

(21) Appl. No.: 18/717,158

(22) PCT Filed: Dec. 9, 2022
(86) PCT No.: PCT/QA2022/050023

§ 371 Date: Jun. 6, 2024

Related U.S. Application Data
(60) Provisional application No. 63/287,714, filed on Dec. 9, 2021.

(51) Int. Cl. G01N 17/04

(52) U.S. Cl. CPC G01N 17/043

(57) ABSTRACT

A coupon system for evaluating underdeposit corrosion relating to an industrial pipeline includes a first coupon body, and a second coupon body configured to be coupled to the first coupon body so that the first coupon body covers at least a portion of the second coupon body. The second coupon body is configured to receive one or more corrosive materials in a space formed between the first coupon body and the second coupon body.

### PRIORITY CLAIM

The present application claims priority to and the benefit of U.S. Provisional Patent Application No. 63/287,714, filed on Dec. 9, 2021, the entirety of which is incorporated herein by reference.

### BACKGROUND

Corrosion, one of the most crucial problems, jeopardizes various industries like oil, gas, petrochemical, ammonia, and other infrastructure projects like water desalination and sanitation. Corrosion may cause a loss of billions of U.S. dollars per year and lead to several human and environmental disasters. Underdeposit corrosion (UDC) is the dominant factor behind the failures and leaks in pipelines or tanks of oil and gas industries, and it is responsible for 20% of corrosion failures in oil and gas pipelines.

### SUMMARY

The present disclosure generally relates to monitoring/evaluating corrosion and estimating the efficiency of the UDC inhibitors and other corrosion inhibitors on a laboratory scale or in the industry field.

In light of the present disclosure, and without limiting the scope of the disclosure in any way, in an aspect of the present disclosure, which may be combined with any other aspect listed herein unless specified otherwise, a coupon system for evaluating UDC relating to an industrial pipeline is provided. The coupon system includes a first coupon body, and a second coupon body configured to be coupled to the first coupon body so that the first coupon body covers at least a portion of the second coupon body. The second coupon body is configured to receive one or more corrosive materials in a space formed between the first coupon body and the second coupon body.

In an aspect of the present disclosure, which may be combined with any other aspect listed herein unless specified otherwise, the second coupon body is divided into a plurality of sections.

In an aspect of the present disclosure, which may be combined with any other aspect listed herein unless specified otherwise, the second coupon body is configured to receive the one or more corrosive materials on at least one of the plurality of sections.

In an aspect of the present disclosure, which may be combined with any other aspect listed herein unless specified otherwise, the plurality of sections are defined by one or more dividers.

In an aspect of the present disclosure, which may be combined with any other aspect listed herein unless specified otherwise, the one or more dividers are removably attached to the second coupon body.

In an aspect of the present disclosure, which may be combined with any other aspect listed herein unless specified otherwise, the one or more dividers protrude from a surface of the second coupon body.

In an aspect of the present disclosure, which may be combined with any other aspect listed herein unless specified otherwise, the first coupon body includes one or more grooves configured to receive the one or more dividers.

In an aspect of the present disclosure, which may be combined with any other aspect listed herein unless specified otherwise, the first coupon body has a perforated structure including a plurality of through-holes.

In an aspect of the present disclosure, which may be combined with any other aspect listed herein unless specified otherwise, the coupon system further comprises a fastener configured to secure the first coupon body to the second coupon body.

In an aspect of the present disclosure, which may be combined with any other aspect listed herein unless specified otherwise, each of the first coupon body and the second coupon body includes a hole configured to receive the fastener.

In an aspect of the present disclosure, which may be combined with any other aspect listed herein unless specified otherwise, the fastener comprises at least one of a bolt, a screw, a nut, and a washer.

In an aspect of the present disclosure, which may be combined with any other aspect listed herein unless specified otherwise, at least one of the first coupon body and the second coupon body is in a circular shape.

In an aspect of the present disclosure, which may be combined with any other aspect listed herein unless specified otherwise, a diameter of the first coupon body is the same as a diameter of the second coupon.

In an aspect of the present disclosure, which may be combined with any other aspect listed herein unless specified otherwise, the one or more corrosive materials comprise a material selected from the group consisting of FeS, FeS₂, FeCO₃, SiO₂, and any combinations thereof.

In some examples, a coupon device for evaluating UDC relating to an industrial pipeline is provided. The coupon device comprises a first coupon body, a second coupon body removably coupled to the first coupon body, and one or more corrosive materials disposed between the first coupon body and the second coupon body.

The reader will appreciate the foregoing details, as well as others, upon considering the following detailed description of certain non-limiting embodiments including a coupon system/device for monitoring corrosion and estimating the efficiency of the UDC/other corrosion inhibitors according to the present disclosure.

### BRIEF DESCRIPTION OF THE FIGURES

FIG. 1A illustrates a top view of a coupon system/device according to an example of the present disclosure.

FIG. 1B illustrates a cross-sectional view of the coupon system/device of FIG. 1A along the line of 1B-1B.

FIG. 1C illustrates a side view of the coupon system/device of FIG. 1A.

FIG. 2 illustrates a top view of a second coupon body of the coupon system/device of FIG. 1A according to an example of the present disclosure.

FIG. 3 illustrates an example coupon system/device according to an example of the present disclosure for lab measurements.

FIG. 4 illustrates a coupon system/device (e.g., top surface of the second coupon body) according to the present disclosure, which is tested (a) at pH 7 in the absence of CR82, (b) at pH 7 in the presence of CR82, (c) at pH 3 in the absence of CR82, and (d) at pH 3 in the presence of CR82 after 24 hours of immersion before removing the corrosion products.

FIG. 5 illustrates a coupon system/device according to the present disclosure, which is tested (a) at pH 7 in the absence of CR82, (b) at pH 7 in the presence of CR82, (c) at pH 3 in the absence of CR82, and (d) at pH 3 in the presence of CR82 after 24 hours of immersion after removing the corrosion products.

FIG. 6 illustrates SEM images for a coupon system/device according to the present disclosure, which is tested at pH 7 before removing the corrosion product layer: (a) bare, (b) SiO₂, (c) FeS, and (d) FeS₂.

FIG. 7 illustrates SEM images for a coupon system/device according to the present disclosure, which is tested at pH 7 after removing the corrosion product layer: (a) bare, (b) SiO₂, (c) FeS, and (d) FeS₂.

FIG. 8 illustrates SEM images for a coupon system/device according to the present disclosure, which is tested at pH 7 after removing the corrosion product layer in the presence of 400 ppm of CR82: (a) bare, (b) SiO₂, (c) FeS, and (d) FeS₂.

FIG. 9 illustrates optical microscope images for a coupon system/device according to the present disclosure, which is tested at pH 7 after removing the corrosion product layer: (a) bare, (b) SiO₂, (c) FeS, and (d) FeS₂.

FIG. 10 illustrates optical microscope images for a coupon system/device according to the present disclosure, which is tested at pH 7 after removing the corrosion product layer in the presence of 400 ppm of CR82: (a) bare, (b) SiO₂, (c) FeS, and (d) FeS₂.

FIG. 11 illustrates optical microscope images for a coupon system/device according to the present disclosure, which is at pH 3 after removing the corrosion product layer: (a) bare, (b) SiO₂, (c) FeS, and (d) FeS₂.

FIG. 12 illustrates optical microscope images for a coupon system/device according to the present disclosure, which is at pH 3 after removing the corrosion product layer in the presence of 400 ppm of CR82: (a) bare, (b) SiO₂, (c) FeS, and (d) FeS₂.

FIG. 13A illustrates an outside portion of a first coupon body and a second coupon body of a coupon device/system according to an example of the present disclosure.

FIG. 13B illustrates an inside portion of the first coupon body and the second coupon body of the coupon device/system of FIG. 13A.

FIG. 14A illustrates the outside portion of the first coupon body and the second coupon body of the coupon device/system of FIG. 13A after retrieval of the coupon system/device from a field test.

FIG. 14B illustrates the inside portion of the first coupon body and the second coupon body of the coupon device/system of FIG. 13A after retrieval of the coupon system/device from the field test.

FIG. 15A illustrates the outside portion of the first coupon body and the second coupon body of the coupon device/system of FIG. 13A after cleaning.

FIG. 15B illustrates the inside portion of the first coupon body and the second coupon body of the coupon device/system of FIG. 13A after cleaning.

### DETAILED DESCRIPTION

The present disclosure generally relates to monitoring/evaluating corrosion and estimating the efficiency of the UDC inhibitors and other corrosion inhibitors on a laboratory scale or in the industry field.

UDC may be the dominant factor behind the failures and leaks in pipelines or tanks of oil and gas industries and responsible for about 20% of corrosion failures in oil and gas pipelines. The early detection of the UDC can save a significant amount of corrosion-related costs, prevent catastrophic infrastructure failures, protect the environment, and decrease property damage.

Conventional corrosion coupons and related reports have focused mainly on monitoring the corrosion rate based on the weight loss without the feasibility for qualitative or quantitative analysis. Moreover, the conventional coupons are fixed (not rotated), integrated inside the pipelines on the surface, and cannot work in laminar flow/turbulent flow solutions. In addition, the conventional coupons are disposable and not feasible for recycling or reuse. Furthermore, the conventional coupons and related reports have only focused on corrosion without considering the UDC.

Aspects of the present disclosure provide a new, low-cost, efficient, durable, and practical coupon system/device for quick (e.g., within 24 hours) monitoring the performance of the UDC (i.e., single or multiple inhibitors) in different media under different types of deposits, different pH (i.e., acidic, neutral, alkaline), different media (i.e., organic, inorganic, and hybrid), and feasible for lap scale and industry scale (e.g., high temperature, pressure, and solution flow speed). The coupon system/device according to the present disclosure can be easily used several times and recycled easily without the need for expensive/complicated laboratory equipment and skills. The coupon system/device according to the present disclosure may work in the pipelines under laminar flow or turbulent conditions (0.01 to 4 m/s) while it is self-fixed or rotated with a speed of 1 to 5000 rpm. The coupon system/device according to the present disclosure may allow investigation of the UDC and regular corrosion inhibitors performance using an image analysis app-assisted cellphone camera and/or advanced optical microscope.

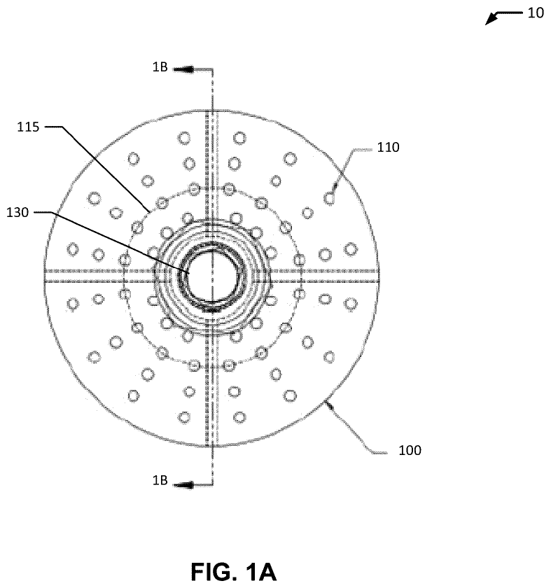

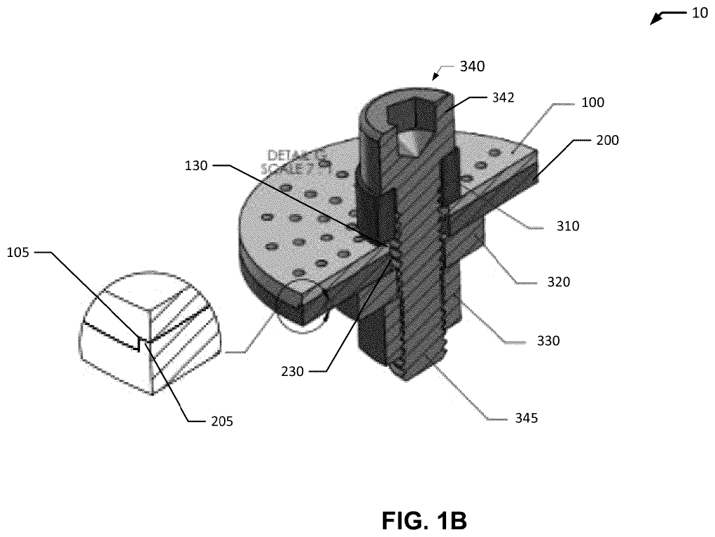

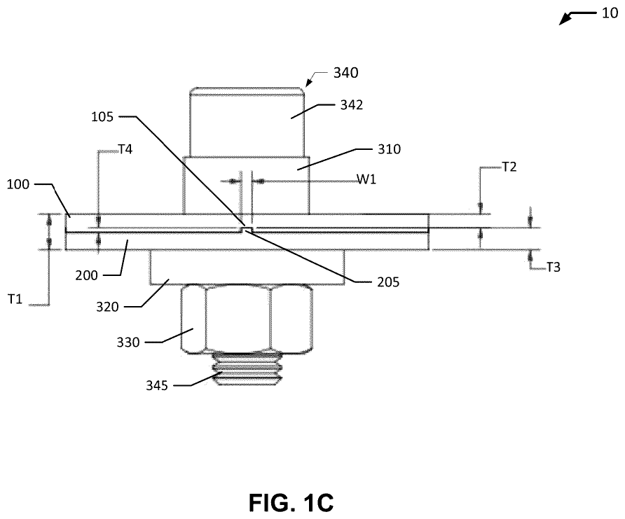

Referring to FIGS. 1A-1C, according to an embodiment of the present disclosure, a coupon system/device 10 for evaluating UDC relating to an industrial pipeline may be provided. The coupon system/device 10 may include a first coupon body 100 and a second coupon body 200. The second coupon body 200 may be configured to be coupled to the first coupon body 100. When the second coupon body 200 is coupled to the first coupon body 100, the first coupon body 100 covers at least a portion or the entire portion of the top surface of the second coupon body 200.

The second coupon body 200 may receive one or more corrosive materials in a space formed between the first coupon body 100 and the second coupon body 200. The one or more corrosive materials may include FeS, FeS₂, FeCO₃, SiO₂, or any combinations thereof.

In some examples, the diameter of the first/second coupon body 100/200 may be in a range of about 2 cm to about 10 cm. In other examples, the first/second coupon body 100/200 may have any other suitable diameter (e.g., lower than 2 cm or greater than 10 cm). In some examples, the diameter of the first coupon body 100 is the same as the diameter of the second coupon 200. In other examples, the diameter of the first coupon body 100 is different from the diameter of the second coupon 200.

In the present disclosure, the term “diameter” is used for simplicity, and there is no requirement that the component described using the term “diameter” has a circular shape. When the component is non-circular, the term “diameter” may instead refer to any similarly used measurement across the component (e.g., width), as will be understood by one of ordinary skill in the art.

In some examples, the first coupon body 100 and/or the second coupon body 200 may have a circular shape. In other examples, the first coupon body 100 and/or the second coupon body 200 may have any other suitable shape, such as oval, ellipse, triangle, rectangular, square, pentagon, hexagon, heptagon, octagon, or any other suitable polygonal, convex, or concave shape, or combinations thereof. In some examples, the first coupon body 100 and the second coupon body 200 may have the same shape. In other examples, the first coupon body 100 and the second coupon body 200 may have a shape different from each other.

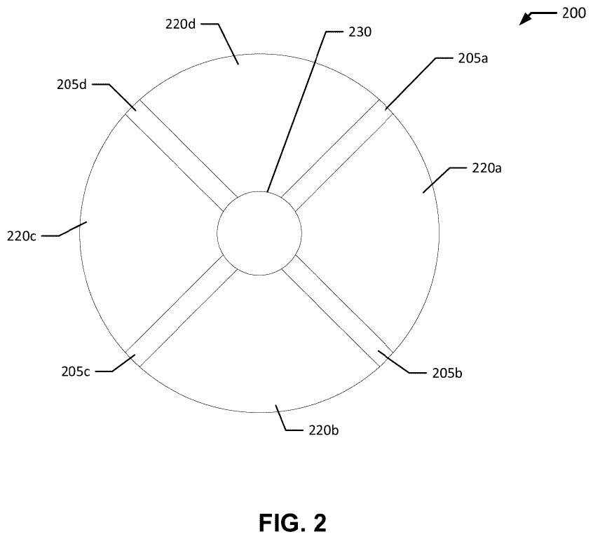

FIG. 2 illustrates the second coupon 200 body according to an example of the present disclosure. As shown in FIG. 2, in some examples, the second coupon body 200 may be divided into a plurality of sections 220a-d. The second coupon body 200 may receive the one or more corrosive materials on at least one of the plurality of sections 220a-d. In some examples, the number of the sections 220a-d may be in range of 2 to 10. In other examples, the number of the sections 220a-d may have any other suitable value (e.g., lower than 2 or greater than 10).

In some examples, the sections 220a-d may include deposits of different corrosion products. For example, a first section 220a may include FeS, a second section 220b may include FeS₂, a third section 220c may include FeCO₃, and a fourth section 220d may include SiO₂. In some examples, at least one of the sections 220a-d may be kept empty as a control cell. For example, the third section 220c may include no deposit as a control section.

The plurality of sections 220a-d of the second coupon body 200 may be defined by one or more dividers 205a-d. In some examples, the one or more dividers 205a-d may be removably attached to the second coupon body 200. In other examples, the one or more dividers 205a-d may be integrally formed with the second coupon body 200. The one or more dividers 205a-d may protrude from a surface (e.g., top surface) of the second coupon body 200.

In some examples, the first coupon body 100 may include one or more grooves 105 configured to receive the one or more dividers 205. In some examples, the first coupon body 100 may have a perforated structure. For example, the first coupon body 100 may include a plurality of through-holes 110. In some examples, the through-holes 110 may be formed on a virtual circle 115. In some examples, the first coupon body 100 may include a plurality of virtual circles 115 having a diameter different from each other. In this case, the through-holes 110 may be formed on the plurality of virtual circles having different diameters. In some examples, the through-holes 110 may have a diameter in a range of 0.1 mm to 1.0 mm. In other examples, the through-holes 110 may have any other suitable diameter.

In some examples, the coupon system/device 10 may include a fastener configured to secure the first coupon body 100 to the second coupon body 200. In some examples, the fastener may include a bolt or a screw 340. In some examples, the first coupon body 100 and the second coupon body 200 may include a first hole 130 and a second hole 230, respectively. The first and second holes 130, 230 may be configured to receive the fastener.

In some examples, the fastener may further include a nut 330. The nut is configured to be attached to the bolt/screw 340 to prevent the bolt/screw 340 to move in an axial direction of the bolt/screw 340, thereby securing the first coupon body 100 and the second coupon body 200 to each other between the nut 330 and a head 342 of the bolt/screw 340. The bolt/screw 340 may include a threaded shaft 345, and the nut 340 may include a hole with a female thread that is configured to have a threaded engagement with the threaded shaft 345 of the bolt/screw 340. In some examples, the fastener may further include a washer 320 and/or a spacer 310.

In some examples, the combined thickness T1 of the first coupon body 100 and the second coupon body 200 may be in a range of 1 cm to 5.5 cm. In other examples, the combined thickness T1 of the first coupon body 100 and the second coupon body 200 may have any other suitable value (e.g., lower than 1 cm or greater than 5.5 cm). The thickness T2 of the first coupon body 100 from the groove 105 to the top surface thereof may be in a range of 0.5 cm to 2.5 cm. In other examples, the thickness T2 of the first coupon body 100 from the groove 105 to the top surface thereof may have any other suitable value (e.g., lower than 0.5 cm or greater than 2.5 cm).

The thickness T3 of the second coupon body 200 from the bottom surface to the top surface of the divider 205 may be in a range of 0.5 cm to 3 cm. In other examples, the thickness T3 of the second coupon body 200 from the bottom surface to the top surface of the divider 205 may have any other suitable value (e.g., lower than 0.5 cm or greater than 3 cm).

The thickness T4 of the divider 205 may be in a range of 0.2 cm to 0.8 cm. In other examples, the thickness T4 of the divider 205 may have any other suitable value (e.g., lower than 0.2 cm or greater than 0.8 cm).

The width W1 of the divider 205 may be in a range of 0.5 cm to 1.5 cm. In other examples, the width W1 of the divider 205 may have any other suitable value (e.g., lower than 0.5 cm or greater than 1.5 cm).

The coupon system/device 10 may be used to evaluate UDC in a laboratory setting or in an industrial pipeline during processing. The coupon system/device 10 may be used to evaluate UDC, including evaluating an efficiency of one or more corrosion inhibitors used in an industrial pipeline during processing.

In some examples, the coupon system/device 10 (e.g., first coupon body 100 and second coupon body 200) may be made of a C-steel sheet or any suitable material, including any other suitable metallic material depending on the materials of the pipeline. For example, a low-carbon steel sheet (e.g., A35 grade provided by Qatar Steel) may be machined to be a coupon (e.g., first coupon body 100 and second coupon body 200). Different grits (up to 4000 grits) of emery paper may be used to refine the steel specimens' surfaces. Then, the specimens may be degreased by rinsing with acetone and deionized water before reaction. In some examples, the coupon system/device 10 (e.g., first coupon body 100 and second coupon body 200) may be made from earth-abundant, low-cost, and commercially available materials, such as Fe-based alloy or any metals or alloys, including but not limited to Mg-based alloy, Ti-based alloy, Ni-based alloy, Cu-based alloy, and Al-based alloys.

Aspects of the present disclosure may provide a new, low-cost, efficient, durable, and practical coupon system/device to measure the uniform corrosion rate, measure the UDC rate, and evaluate the corrosion inhibitors' and UDC inhibitors' efficiency in the laboratory or the pipelines under laminar or turbulent flow conditions. Using the coupon system/device 10 according to the present disclosure, the efficiency could be easily investigated promptly (within 24 hours up to several months) in different media (sour media and under different pH values) using the naked eye/optical microscope with image analysis software. Also, the qualitative estimation could be easily performed using an imaging analysis application and/or a smartphone. The coupon system/device 10 may have a simple structure and may be feasible for practical applications.

In some examples, the coupon system/device 10 may be put in different media at different pH values in the presence or absence of any corrosion inhibitor, e.g., CR82 corrosion inhibitor (e.g., blended from Baker Hughes used in the field by Qatar Shell). After 24 hours, in the absence of CR82, the coupon may be collected. Significant changes may be observed under the deposit, such as a change in color observed by the naked eye and distribution of various pits with different aspect ratios (aspect ratio=1/a, where I is the pit depth and a is the pit mouth area) that can be observed by optical microscope or even a mobile phone. After 24 hours, in the presence of CR82, a slight change is observed. The deposits can be changed to anything related to UDC or usual corrosion, whereas the CR82 can also be changed to any other inhibitors under the same procedure.

In some examples, the coupon system/device 10 may be directly implemented in the pipelines for different times, then collected and examined at the large-scale applications in the industrial fields. If there are any corrosion inhibitors used in the pipelines, a slight amount of inorganic ions may be deposited, while in the absence of corrosion inhibitors, substantial changes in the shape and depositions may be formed on the coupon that are subsequently examined by imaging analysis to determine the aspect ratio and the number of pits per unit area. The coupon system/device 10 may act as an indicator or sensor for the prompt monitoring of the UDC or uniform corrosion in the pipelines. The fabrication process of the coupon system/device 10 may be simple and easy, for example, without having to use any kind of advanced equipment or special laboratory skills.

The coupon system/device 10 according to the present disclosure may allow a quantitative estimation of the UDC inhibitors' efficiency in different pH values (acidic, neutral, and alkaline) and different media (sour, mixed, and sweet media) under ambient or high temperature and pressure. The coupon system/device 10 can be used in pipelines under laminar or turbulent flow conditions.

In some examples, the coupon system/device 10 according to the present disclosure may work in the pipelines under laminar or turbulent flow conditions (0-4 m s⁻¹). The coupon system/device 10 can work while it is still or rotated, for example, with a speed of 1 to 6000 rpm. The coupon system/device 10 may work under different pH values, including acidic (pH=1 to 6.5), alkaline (pH=7.5 to 12), and neutral (pH=6.5-7.5). The coupon system/device 10 may work in sour media and sweet media under real operating conditions like high temperature and pressure. The coupon system/device 10 could be used for estimating the efficiency of UDC inhibitors under different types of deposits, either separate or mixed simultaneously at the same time. The number, size, and distribution of the pores/holes in the coupon system/device 10 (e.g., first coupon plate) can be adjusted according to the end-users operating conditions.

The coupon system/device 10 can be used for estimating the efficiency of UDC and other types of corrosion inhibitors, e.g., but not limited to uniform and localized corrosion inhibitors. The coupon device may allow the immediate, efficient, and accurate (100%) evaluation process quickly (e.g., within only 24 hours) in different media and under different pH values at the laboratory scale or under prolonged exposure within the pipelines in the field. The coupon system/device 10 may allow investigation of the corrosion inhibitors' performance using naked eyes, an optical microscope, or a cellphone camera with the assistant of the imaging analysis process to evaluate the number of pits/area beside the aspect ratio of the pits (pit depth/pit mouth area).

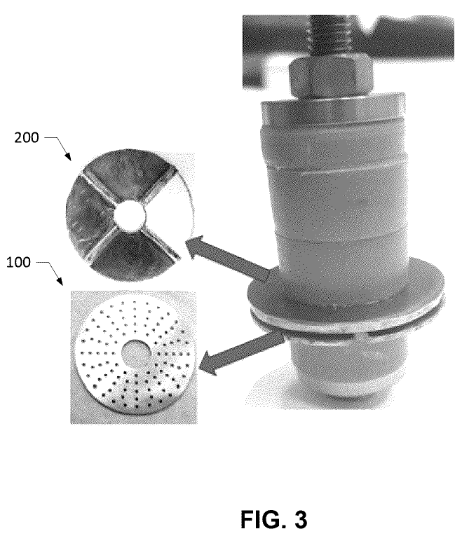

The coupon system/device 10 may work at different temperatures (e.g., about −50 to about 400° C.) and under high pressure (e.g., about 1 to about 400 bar). The coupon system/device 10 may work in organic media, inorganic media, and hybrid media. The coupon system/device 10 can be used to identify the efficiency of the UDC inhibitors and other corrosion inhibitors in oil and gas pipelines and other end-use industrial pipelines like power generation, ammonia, oil/gas, mining, metal processing, fertilizers, petrochemicals, water desalination, wastewater treatment plant, and chemical processing. The coupon system/device 10 may include multiple cells/sections with different deposits. At the laboratory scale, the coupon system/device 10 can contain any kind of insoluble deposits. FIG. 3 shows an example coupon system/device for lab measurements.

The coupon system/device 10 according to the present disclosure may be mobile, thermally stable (up to 400° C.), and have excellent mechanical properties (Young's modulus of 190 GPa at room temperature, hardness up to 200 MPa). The coupon system/device 10 may be highly chemically stable in water and in organic/inorganic/hybrid media.

The coupon system/device 10 can be in any geometric shape, including but not limited to flat, cylindrical, disc, scale, and rod. The coupon device holder may be designed in the form of a cylinder, flat, disc, retractable, retrievable coupon, bottle cap, adjustable, fixed (pipe Plug), or modified in any design. The coupon system/device 10 may be applicable to all environments, including gases, liquids, hybrid, and solids/particulate flow. The coupon system/device 10 may be used for investigating the rate and efficiency of the corrosion inhibitors in the presence or absence of deposits in the laboratory or the field. The coupon system/device 10 may be used for the investigation of the needed amount of corrosion inhibitors in the laboratory or the field.

### EXAMPLES

### Example 1

A low-carbon steel sheet, A35 grade (provided by Qatar Steel) is machined to be a coupon with a 5 cm diameter and 30 mm length. Different grits (up to 4000 grits) of emery paper were used to refine the steel specimens' surfaces. Then, the specimens are degreased by rinsing with acetone and deionized water before reaction. All solutions have been prepared from pure reagents procured from Sigma-Aldrich (St. Louis, Missouri, USA). Three different inhibitors (CRW85411, CRW85719, and CRW85282) from Baker Hughes were used in different concentrations (5, 10, 25, 50, 100, 200, 300, 400, and 500 ppm) to evaluate their efficiencies before and after scale formations. After that, the chosen optimum concentration of each inhibitor is used in the presence of the different deposits (FeS, FeS₂, and SiO₂), which were purchased from Sigma-Aldrich, United Kingdom, to detect the under deposits corrosion. For simplification, the inhibitors are referred to as CR11, CR19, and CR82, respectively.

Three different deposits, iron sulfide (FeS), iron disulfide (FeS₂), and sand mesh with 100 μm (SiO₂), were utilized to imitate the formed deposits in the pipeline. For the deposit application, 0.3 mg of the required material was dispersed in a solution of 0.6 mL isopropyl alcohol and 0.4 mL Nafion (5 wt %), and the solution was sonicated for two hours. Then, 10 μL of the dispersion deposit was cast onto the J55 steel (any other metallic material in fine) surface and dried for two hours. After that, the prepared electrode was put on 80° C. for four hours to make a compact layer of deposit.

TABLE 1
Chemicals and materials used for experimental work

| Material Description | Source |
|---|---|
| Low-carbon steel sheet, | Qatar steel (Doha, Qatar) |
| A35 grade | |
| Sodium chloride, 99.5% | Sigma-Aldrich Chemie GmbH (Munich, |
| (NaCl) | Germany) |
| Ethanol, 99.9% | Sigma-Aldrich Chemie GmbH (Munich, |
| (C₂H₅OH) | Germany) |
| Sodium Sulfide, 99.5% | Sigma-Aldrich Chemie GmbH (Munich, |
| (Na₂S) | Germany) |
| Carbon dioxide, 99.999% | National Industrial Gas Plants, NIGP |
| (CO₂) | (Doha, Qatar) |
| Iron(II) sulfide, 99.9% | Sigma-Aldrich Chemie GmbH (Munich, |
| (FeS) - 100 mesh | Germany) |
| Iron disulfide, 99.8% | Sigma-Aldrich Chemie GmbH (Munich, |
| (FeS₂) - 325 mesh | Germany) |
| Sand, white Quartz (SiO₂) | Sigma-Aldrich Chemie GmbH (Munich, |
| 50-70 mesh | Germany) |
| Nafion D-521 5% w/w in | Alfa Aesar, Ward Hill, United States |
| water and 1-propanol | |
| Sodium Hydroxide, 97% | VWR, Leuven, Belgium |
| (NaOH) | |
| Hydrochloric acid 38% | Sigma-Aldrich Chemie GmbH (Munich, |
| (HCl) | Germany) |
| CRW85719 | BKER HUGHES |
| | (Liverpool, United Kingdom) |
| CRW85411 | BKER HUGHES |
| | (Liverpool, United Kingdom) |
| CRW85282 | BKER HUGHES |
| | (Liverpool, United Kingdom) |

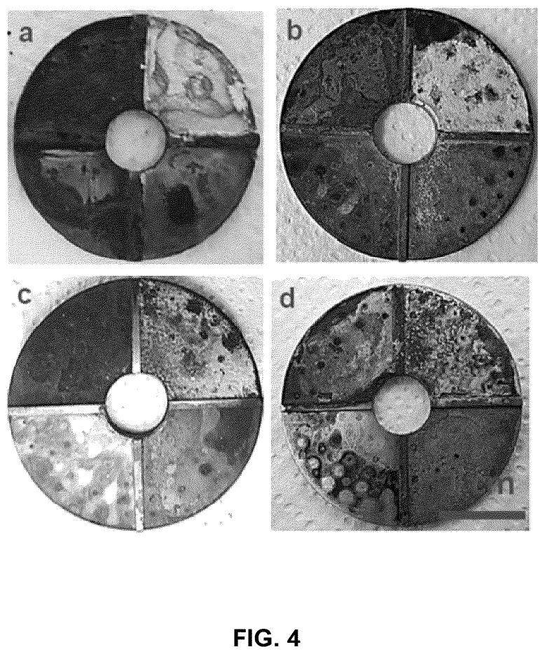

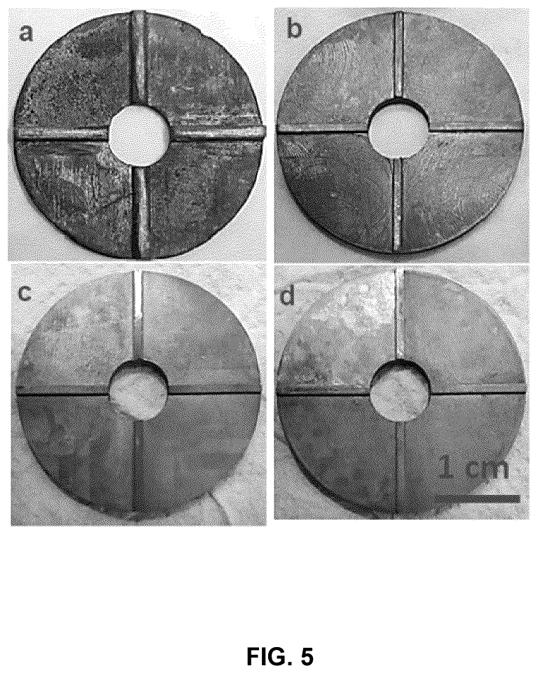

FIG. 4 illustrates the coupon system/device (e.g., top surface of the second coupon body) tested (a) at pH 7 in the absence of CR82, (b) at pH 7 in the presence of CR82, (c) at pH 3 in the absence of CR82, and (d) at pH 3 in the presence of CR82 after 24 hours of immersion before removing the corrosion products. FIG. 5 illustrates the tested coupon system/device (a) at pH 7 in the absence of CR82, (b) at pH 7 in the presence of CR82, (c) at pH 3 in the absence of CR82, and (d) at pH 3 in the presence of CR82 after 24 hours of immersion after removing the corrosion products.

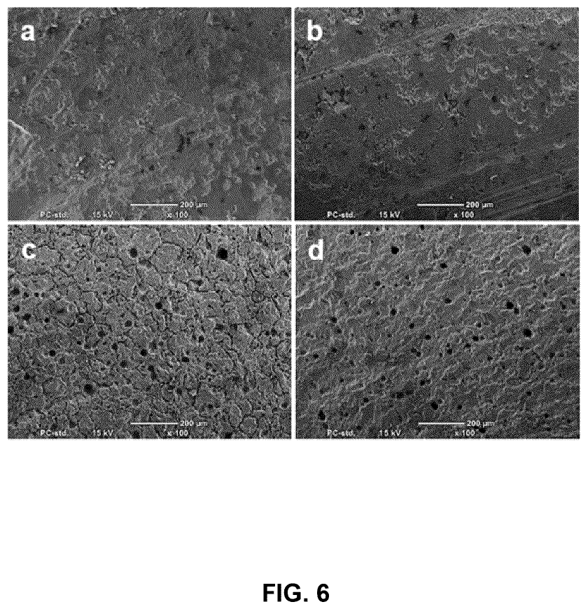

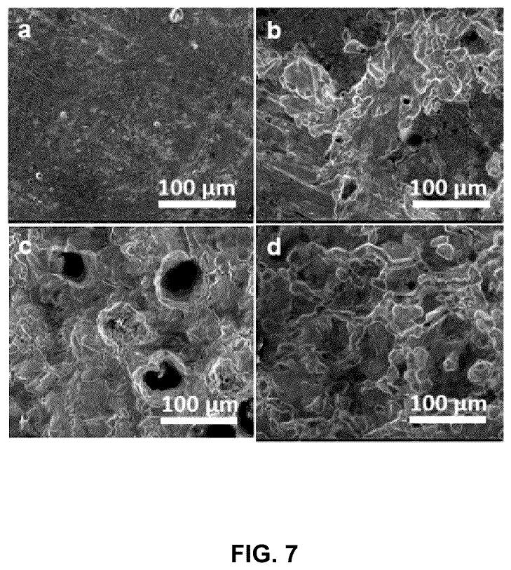

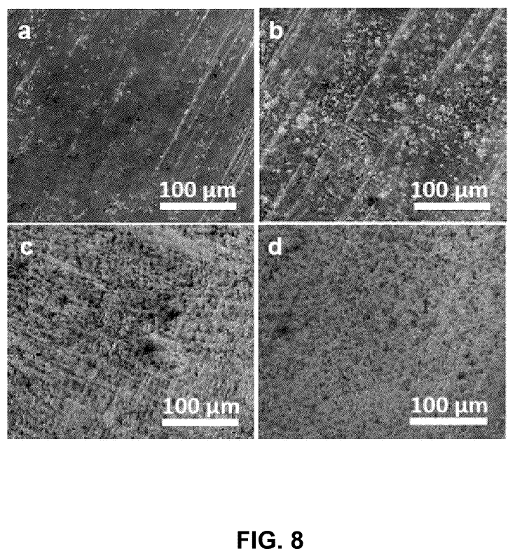

FIG. 6 shows SEM images for the exposed coupon system/device at pH 7 before removing the corrosion product layer: (a) bare, (b) SiO₂, (c) FeS, and (d) FeS₂. FIG. 7 shows SEM images for the exposed coupon system/device at pH 7 after removing the corrosion product layer: (a) bare, (b) SiO₂, (c) FeS, and (d) FeS₂. FIG. 8 shows SEM images for the exposed coupon system/device at pH 7 after removing the corrosion product layer in the presence of 400 ppm of CR82: (a) bare, (b) SiO₂, (c) FeS, and (d) FeS₂.

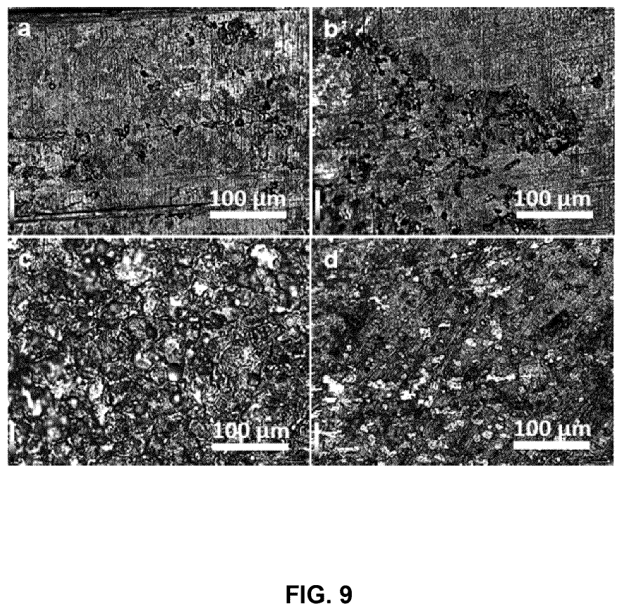

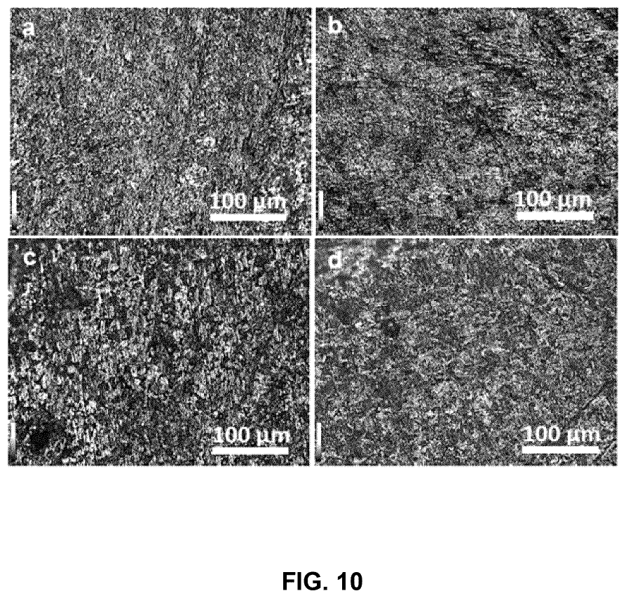

FIG. 9 shows optical microscope images for the exposed coupon system/device at pH 7 after removing the corrosion product layer: (a) bare, (b) SiO₂, (c) FeS, and (d) FeS₂. FIG. 10 shows optical microscope images for the exposed coupon system/device at pH 7 after removing the corrosion product layer in the presence of 400 ppm of CR82: (a) bare, (b) SiO₂, (c) FeS, and (d) FeS₂.

Table 2 below shows the depth, size, and number of pits of the steel specimens exposed in sour media for 24 hours at pH 7 in the absence and presence of 400 ppm of CR82, according to ASTM G46-94.

TABLE 2

| | | | | | | | Aspect | |
|---|---|---|---|---|---|---|---|---|
| | | | | | | | ratio, | |
| | | Pit | | | | Pitting | Avg./ | Corrosion |
| | | density, | | | Av. Size | factor, | size, ×10⁻³ | rate, ×10⁻³ |
| | Sample | cm⁻² | Max | Avg. | (μm²) | Max/avg. | μm⁻¹ | mpy |
| pH 7 | blank | 302 | 0.05 | 0.03 | 35.49 | 1.67 | 0.846 | 1.18 |
| | SiO₂ | 646 | 0.01 | 0.01 | 102.8 | 1 | 0.097 | 0.39 |
| | FeS | 1269 | 0.12 | 0.08 | 214.1 | 1.5 | 0.373 | 3.15 |
| | FeS₂ | 882 | 0.1 | 0.06 | 173.2 | 1.67 | 0.346 | 2.36 |
| CR82 | blank | 180 | 0.01 | 0.01 | 7.105 | 1 | 1.407 | 0.39 |
| | SiO₂ | 461 | 0.01 | 0.01 | 8.054 | 1 | 1.249 | 0.39 |
| | FeS | 946 | 0.02 | 0.01 | 20.21 | 2 | 0.494 | 0.39 |
| | FeS₂ | 324 | 0.02 | 0.01 | 14.97 | 2 | 0.669 | 0.39 |

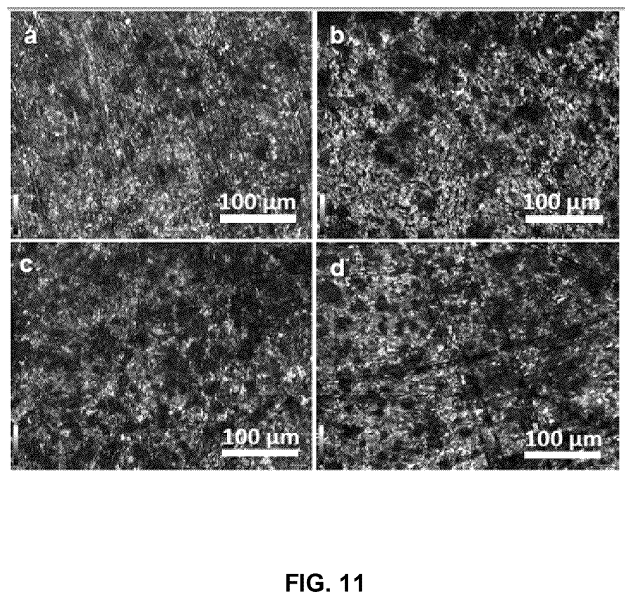

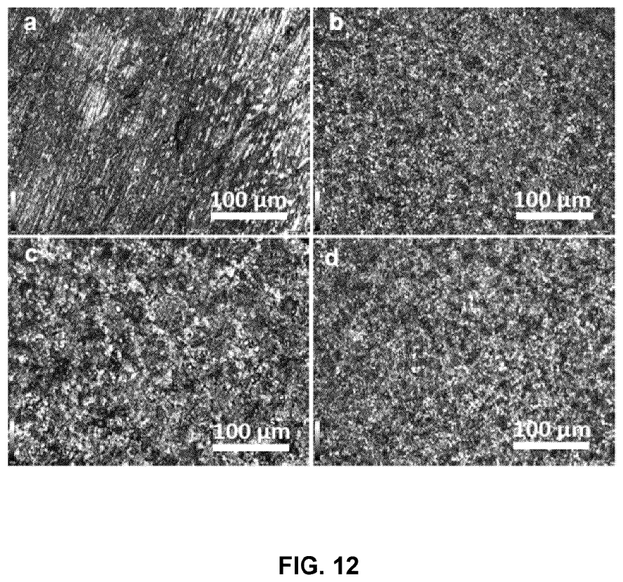

FIG. 11 shows optical microscope images for the exposed coupon system/device at pH 3 after removing the corrosion product layer: (a) bare, (b) SiO₂, (c) FeS, and (d) FeS₂. FIG. 12 shows optical microscope images for the exposed coupon system/device at pH 3 after removing the corrosion product layer in the presence of 400 ppm of CR82: (a) bare, (b) SiO₂, (c) FeS, and (d) FeS₂. Table 3 below shows the depth, size, and number of pits of steel specimens exposed in sour media for 24 h at pH 3 in the absence and the presence of 400 ppm of CR82, according to ASTM G46-94.

TABLE 3

| | | | | | | | Aspect | |
|---|---|---|---|---|---|---|---|---|
| | | | | | | | ratio, | |
| | | Pit | | | | Pitting | Avg./ | Corrosion |
| | | density, | | | Av. Size | factor, | size, ×10⁻³ | rate, ×10⁻³ |
| | Sample | cm⁻² | Max | Avg. | (μm²) | Max/avg. | μm⁻¹ | mpy |
| pH 3 | blank | 1024 | 0.16 | 0.12 | 172.8 | 1.33 | 0.694 | 4.72 |
| | SiO₂ | 2087 | 0.18 | 0.14 | 295.8 | 1.28 | 0.473 | 5.51 |
| | FeS | 2943 | 0.28 | 0.2 | 440.9 | 1.41 | 0.453 | 7.88 |
| | FeS₂ | 2761 | 0.22 | 0.17 | 356.5 | 1.29 | 0.476 | 6.69 |
| CR82 | blank | 389 | 0.01 | 0.01 | 40.57 | 1 | 0.246 | 0.39 |
| | SiO₂ | 1006 | 0.06 | 0.04 | 32.95 | 1.5 | 1.213 | 1.57 |
| | FeS | 661 | 0.08 | 0.05 | 44.095 | 1.6 | 1.133 | 1.97 |
| | FeS₂ | 1405 | 0.12 | 0.061 | 25.65 | 1.96 | 2.377 | 2.40 |

### Example 2

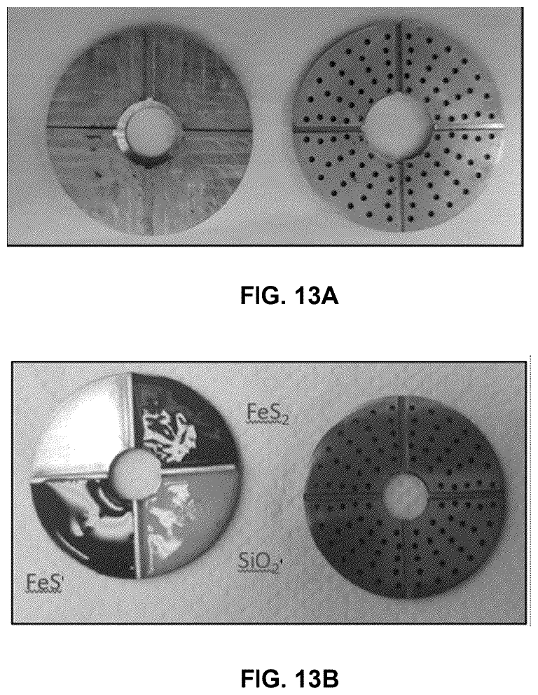

Another example of the coupon system/device is shown in FIGS. 13A-13B. FIGS. 13A and 13B illustrate the outside portion and inside portion of the first coupon body and the second coupon body, respectively. In FIG. 13B, three sections of the second coupon body are deposited with corrosive materials, FeS, FeS₂, and SiO₂. One of the sections of the second coupon body was kept empty as a control cell. The coupon system/device of FIGS. 13A-13B was tested in the field and compared with the conventional coupon device.

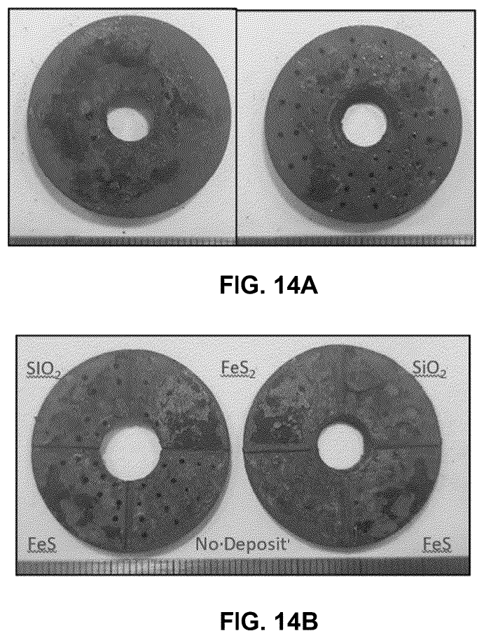

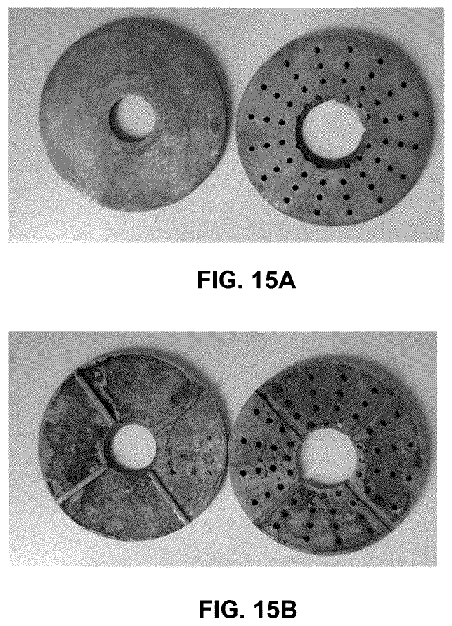

FIGS. 14A and 14B illustrate the outside portion and inside portion of the first coupon body and the second coupon body, respectively, after retrieval of the coupon system/device from the field test. FIGS. 15A and 15B illustrate the outside portion and inside portion of the first coupon body and the second coupon body, respectively, after cleaning. The corrosion rate of the coupon system/device was calculated using the below equation:

Corrosion rate=(K×W)/(A×T×D)mm/yr (equation 1)

where, K=constant=87600 (this value is a conversion factor between different units of corrosion rate), W=mass loss in grams, T=time of exposure in hours (calculated as the difference between installation and removal time), A=area in cm², and D=density in g/cm³=7.88 g/cm³ (this is a standard value).

Table 4 below shows the average corrosion rate calculated for the first coupon body, second coupon body, and a conventional coupon device.

TABLE 4

| | Top (first | Bottom (second | Conventional |
|---|---|---|---|
| | coupon body) | coupon body) | Coupon |
| Weight before | 8.0254 | 9.0418 | ~17 |
| installation (g) | | | |
| Weight after retrieval (g) | 7.6387 | 8.1428 | ~18 |
| Weight after cleaning (g) | 7.2751 | 7.7189 | ~17.5 |
| Duration of exposure | 62 | 62 | ~90 |
| (days) | | | |
| Surface area of exposure | 18.66 | 14.14 | 16.1 |
| (cm2) | | | |
| Average corrosion rate | 0.3002 | 0.6988 | 0.001-0.09 |
| (mm/yr) | | | |

Table 5 below shows a classification of the corrosion rate, which shows the level of the corrosion rate: low, moderate, severe, and very severe.

TABLE 5

| Classification | Avg. Corrosion Rate (mm/yr) |
|---|---|
| Low | <0.0254 |
| Moderate | 0.0254-0.1245 |
| Severe | 0.1270-0.2540 |
| Very Severe | >0.2540 |

The corrosion rate of the coupon device/system according to the present disclosure has a value greater than 0.2540 (0.3002 for the first coupon body; 0.6988 for the second coupon body), which is classified as a “very severe” corrosion. On the other hand, the conventional coupon device only showed a corrosion rate of 0.001 to 0.09, which is classified as a “low” or “moderate” corrosion.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B,” “one or more of A and B,” and “A and/or B” are each intended to mean “A alone, B alone, or A and B together.” A similar interpretation is also intended for lists including three or more items. For example, the phrases “at least one of A, B, and C”; “one or more of A, B, and C”; and “A, B, and/or C” are each intended to mean “A alone, B alone, C alone, A and B together, A and C together, B and C together, or A and B and C together.” Use of the term “based on” above and in the claims is intended to mean “based at least in part on,” such that an unrecited feature or element is also permissible.

All ranges described are intended to include all numbers, whole or fractions, contained within the said range. As used herein, “about,” “approximately,” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used herein, the singular forms “a”, “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but they do not preclude the presence or addition of one or more other features, integers, steps, operations, elements, components, and/or groups thereof.

Reference throughout the specification to “various examples,” “some examples,” “one example,” “an example,” “another example,” or the like, means that a particular feature, structure, or characteristic described in connection with the example is included in at least one example. Thus, appearances of the phrases “various examples,” “some examples,” “one example,” “an example,” “another example,” or the like, in places throughout the specification are not necessarily all referring to the same example. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, or characteristics of one or more other embodiments/examples without limitation. Such modifications and variations are intended to be included within the scope of the present invention.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. Moreover, consistent with current U.S. law, it should be appreciated that 35 U.S.C. 112 (f) or pre-AIA 35 U.S.C. 112, paragraph 6 is not intended to be invoked unless the terms “means” or “step” are explicitly recited in the claims. Accordingly, the claims are not meant to be limited to the corresponding structure, material, or actions described in the specification or equivalents thereof.

1. A coupon system for evaluating underdeposit corrosion relating to an industrial pipeline, the coupon system comprising:
a first coupon body; and
a second coupon body configured to be coupled to the first coupon body so that the first coupon body covers at least a portion of the second coupon body, wherein the second coupon body is configured to receive one or more corrosive materials in a space formed between the first coupon body and the second coupon body.

2. The coupon system of claim 1, wherein the second coupon body is divided into a plurality of sections.

3. The coupon system of claim 2, wherein the second coupon body is configured to receive the one or more corrosive materials on at least one of the plurality of sections.

4. The coupon system of claim 2, wherein the plurality of sections are defined by one or more dividers.

5. The coupon system of claim 4, wherein the one or more dividers are removably attached to the second coupon body.

6. The coupon system of claim 4, wherein the one or more dividers protrude from a surface of the second coupon body.

7. The coupon system of claim 6, wherein the first coupon body includes one or more grooves configured to receive the one or more dividers.

8. The coupon system of claim 1, wherein the first coupon body has a perforated structure including a plurality of through-holes.

9. The coupon system of claim 1, further comprising a fastener configured to secure the first coupon body to the second coupon body.

10. The coupon system of claim 9, wherein each of the first coupon body and the second coupon body includes a hole configured to receive the fastener.

11. The coupon system of claim 9, wherein the fastener comprises at least one of a bolt, a screw, a nut, and a washer.

12. The coupon system of claim 1, wherein at least one of the first coupon body and the second coupon body is in a circular shape.

13. The coupon system of claim 1, wherein a diameter of the first coupon body is the same as a diameter of the second coupon.

14. The coupon system of claim 1, wherein the one or more corrosive materials comprise a material selected from the group consisting of FeS, FeS2, FeCO3, SiO2, and any combinations thereof.

15. A coupon device for evaluating underdeposit corrosion relating to an industrial pipeline, the coupon system comprising:
a first coupon body;
a second coupon body removably coupled to the first coupon body; and
one or more corrosive materials disposed between the first coupon body and the second coupon body.

16. The coupon device of claim 15, wherein the second coupon body is divided into a plurality of sections on which the one or more corrosive materials are disposed.

17. The coupon system of claim 16, wherein the plurality of sections are defined by one or more dividers.

18. The coupon system of claim 17, wherein the one or more dividers are removably attached to the second coupon body.

19. The coupon system of claim 17, wherein the first coupon body includes one or more grooves configured to receive the one or more dividers.

20. The coupon system of claim 15, wherein the one or more corrosive materials comprise a material selected from the group consisting of FeS, FeS2, FeCO3, SiO2, and any combinations thereof.
